(19) United States
(12) Patent Application Publication
(10) Pub. No.: US 2013/0016051 A1
(43) Pub. Date: Jan. 17, 2013

(54) Touch Panel Device Having a Divided ITO layer for Reducing Loading

(71) Applicant: Ying-Jyh Yeh, Kaohsiung City (TW)

(72) Inventor: Ying-Jyh Yeh, Kaohsiung City (TW)

(73) Assignee: Silicon Integrated Systems Corp., Hsinchu City (TW)

(21) Appl. No.: 13/450,438

(22) Filed: Apr. 18, 2012

Related U.S. Application Data
(63) Continuation-in-part of application No. 13/182,436, filed on Jul. 13, 2011.

(51) Int. Cl. G06F 3/041

(52) U.S. Cl. 345/173

(57) ABSTRACT

A touch panel device includes a touch panel and two or more controllers. The touch panel includes four regions. Each region includes a plurality of driving conductors extended along a first direction, and a plurality of sensing conductors extended along a second direction perpendicular to the first direction. Each controller is in charge of one of the region. Since the length of each driving conductor and each sensing conductors is one half of that of the conventional driving conductor and sensing conductor, each controller controls one fourth of the area of the touch panel, and is responsible for one fourth of the capacitance of the touch panel. The touch panel device can be well controlled by the controller without using a single controller with higher detecting sensibility and cost.

### CROSS REFERENCE TO RELATED APPLICATION

This is a continuation-in-part of a U.S. patent application Ser. No. 13/182,436, filed on Jul. 13, 2011.

### BACKGROUND OF THE INVENTION

1. Field of the Invention

The present invention relates to a touch panel device, and more particularly, to a touch panel device having a large size touch panel with a divided ITO layer so as to reduce loading.

2. Description of the Prior Art

Advanced displays have gradually become a major feature of today's consumer electronics products. To facilitate portability and utilization, a display device having a touch panel for users to touch directly have been widely used in television sets, smart phones or other electronics products.

To facilitate portability and utilization, a touch panel for a user to touch directly has been the focus in market development. A liquid crystal display (LCD) for a smart phone is usually combined with a touch panel, so that push buttons or function keys can be omitted. The touch panel uses electrical signals to control image displays and functions of the LCD. The electrical signals are produced after the user touches the outer surface of the touch panel.

Referring to FIG. 1, FIG. 1 is a schematic diagram of a touch panel device 10 having a conventional touch panel 11. The touch panel 11 of the touch panel device 10 comprises a sensor array 12 for detecting a touch position and strength of a finger or a pen as it touches the panel. When the finger touches the panel, the resistance or the capacitance of the sensor array 12 made from resistors or capacitors varies. For example, the distance between the upper and lower electrodes will be reduced as the finger press down on the outer surface of the touch panel 11 made from flexible materials, causing the resistance between the upper and lower electrodes to change. Or, the human body capable of conducting electricity will influence the capacitor between the upper and lower electrodes or change the capacitance between upper and lower electrodes as the finger press down on the outer surface of the touch panel 11. By detecting the touch position and the strength of the finger as it touches the panel, variations in the resistance or the capacitance can be measured.

The sensor array 12 is formed by a set of conductors in the X-direction interlaced with a set of conductors in the Y-direction, or is formed by stripped conductors arranged circularly in polar coordinates. Each of the intersections of the X-direction conductors and the Y-direction conductors may be equivalent to a resistor or a capacitor. A controller 14 outputs a driving signal to conduct conductors in one row through the multiplexer 16, and sensing signals of the intersections in each column are sent back to the controller 14 through a multiplexer 18. Accordingly, the touch position and strength of an applied force can be measured by detecting the variety of sensing signals.

Before the user's finger presses down on a point on the outer surface of the touch panel 11, the stripped conductors in the X-direction and in the Y direction have the same potential. Meanwhile, no electric current flows through the touch panel 11. Once the user's finger touches the touch panel 11, the user's body will generate a very small amount of electric current, causing the capacitance which a plurality of nodes neighboring the touch point correspond to change. The controller 14 determines the touched intersections by detecting the variation in ratio between the capacitance of the plurality of the intersections and the capacitance of the touch panel 11. In a fixed time period, the controller 14 counts a number of charging time associated with the capacitance of each intersection. The more the count is, the larger the capacitance of each intersection is. Based on the counts associated with the capacitance of each intersection, the position of the contact intersection is determined.

However, the variation in the capacitance of each of the intersections is not obvious, so the variation in ratio between the capacitance of the plurality of the touched nodes and the capacitance of the touch panel 11 is not obvious, either. Thus, the controller 14 has to be highly sensitive. Since the capacitance of the whole touch panel 11 is proportion to the size of the touch panel 11, the controller 14 requires higher sensitivity to measure the variety of the sensing signal when using a large-size touch panel 11. That increases more cost and complexity of design of the controller 14.

### SUMMARY OF THE INVENTION

It is therefore an object of the present invention is to provide a touch panel device having a large-size touch panel without using high sensitivity controller.

According to the present invention, a touch panel device comprises a touch panel, a first controller, and a second controller. The touch panel comprises a first region, a second area, a third area, and a fourth area. The first area comprises a plurality of first driving conductors extended along a first direction, and a plurality of first sensing conductors extended along a second direction perpendicular to the first direction. The second region comprises a plurality of second driving conductors extended along the first direction, and a plurality of second sensing conductors extended along the second direction. The third region comprises a plurality of third driving conductors extended along the first direction, and a plurality of third sensing conductors extended along the second direction. The fourth region comprises a plurality of fourth driving conductors extended along the first direction, and a plurality of fourth sensing conductors extended along the second direction. The first controller is electrically connected to the first driving conductors, the second driving conductors, the first sensing conductors, and the second sensing conductors. The first controller is used for outputting the plurality of driving signals to drive the plurality of first driving conductors and the plurality of second driving conductors, for receiving the plurality of sensing signals from the plurality of first sensing conductors, and for receiving the plurality of sensing signals from the plurality of second sensing conductors. The second controller is electrically connected to the third driving conductors, the fourth driving conductors, the third sensing conductors, and the fourth sensing conductors. The second controller is used for outputting the plurality of driving signals to drive the plurality of third driving conductors and the plurality of fourth driving conductors, for receiving the plurality of sensing signals from the plurality of third sensing conductors, and for receiving the plurality of sensing signals from the plurality of fourth sensing conductors. Each first driving conductor is not connected to one of the third driving conductor. Each second driving conductor is not connected to one of the fourth driving conductor. Each first sensing conductor is not connected to one of the second sensing conductor. Each third sensing conductor is not connected to one of the fourth sensing conductor.

According to the present invention, a touch panel device comprises a touch panel, a first controller, a second controller, a third controller, and a fourth controller. The touch panel comprises a first region, a second area, a third area, and a fourth area. The first area comprises a plurality of first driving conductors extended along a first direction, and a plurality of first sensing conductors extended along a second direction perpendicular to the first direction. The second region comprises a plurality of second driving conductors extended along the first direction, and a plurality of second sensing conductors extended along the second direction. The third region comprises a plurality of third driving conductors extended along the first direction, and a plurality of third sensing conductors extended along the second direction. The fourth region comprises a plurality of fourth driving conductors extended along the first direction, and a plurality of fourth sensing conductors extended along the second direction. The first controller is electrically connected to the first driving conductors, the second driving conductors, the first sensing conductors, and the second sensing conductors. The first controller is electrically connected to the first driving conductors and the first sensing conductors. The first controller is used for outputting the plurality of driving signals to drive the plurality of first driving conductors, and for receiving the plurality of sensing signals from the plurality of first sensing conductors. The second controller is electrically connected to the second driving conductors and the second sensing conductors. The second controller is used for outputting the plurality of driving signals to drive the plurality of second driving conductors, and for receiving the plurality of sensing signals from the plurality of second sensing conductors. The third controller is electrically connected to the third driving conductors and the third sensing conductors, The third controller is used for outputting the plurality of driving signals to drive the plurality of third driving conductors, and for receiving the plurality of sensing signals from the plurality of third sensing conductors. The fourth controller is electrically connected to the fourth driving conductors and the fourth sensing conductors. The fourth controller is used for outputting the plurality of driving signals to drive the plurality of fourth driving conductors, and for receiving the plurality of sensing signals from the plurality of fourth sensing conductors. Each first driving conductor is not connected to one of the third driving conductor. Each second driving conductor is not connected to one of the fourth driving conductor. Each first sensing conductor is not connected to one of the second sensing conductor. Each third sensing conductor is not connected to one of the fourth sensing conductor.

In one aspect of the present invention, a number of the first driving conductors, a number of the second driving conductors, a number of the third driving conductors, and a number of the fourth driving conductors are identical, and a number of the first sensing conductors, a number of the second sensing conductors, a number of the third sensing conductors, and a number of the fourth sensing conductors are identical.

In another aspect of the present invention, a cross-like gap is located among the first, second, third and fourth regions.

In contrast to the prior art, the touch panel device having a touch panel comprising four regions. Since two or more controller outputs driving signals to each driving conductors in multiple regions simultaneously, the scan rate is increased. In addition, since each controller controls one half or one fourth of the area of the touch panel, and is responsible for one fourth of the capacitance of the touch panel, the touch panel device can be well controlled by the controller without using a single controller with higher detecting sensibility and cost.

These and other features, aspects and advantages of the present disclosure will become understood with reference to the following description, appended claims and accompanying figures.

### BRIEF DESCRIPTION OF THE DRAWINGS

FIG. 1 is a schematic diagram of a touch panel device 10 having a conventional touch panel.

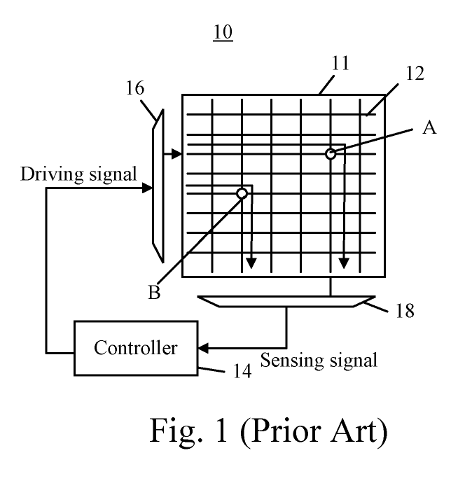

FIG. 2 illustrates a functional block diagram of a touch panel device according to a first embodiment of the present invention.

FIG. 3 shows a touch panel shown in FIG. 2.

FIG. 4 illustrates a functional block diagram of a touch panel device according to a second embodiment of the present invention.

### DETAILED DESCRIPTION OF THE PREFERRED EMBODIMENTS

The following embodiments are exemplified by referring to the accompanying drawings, for describing specific embodiments implemented by the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

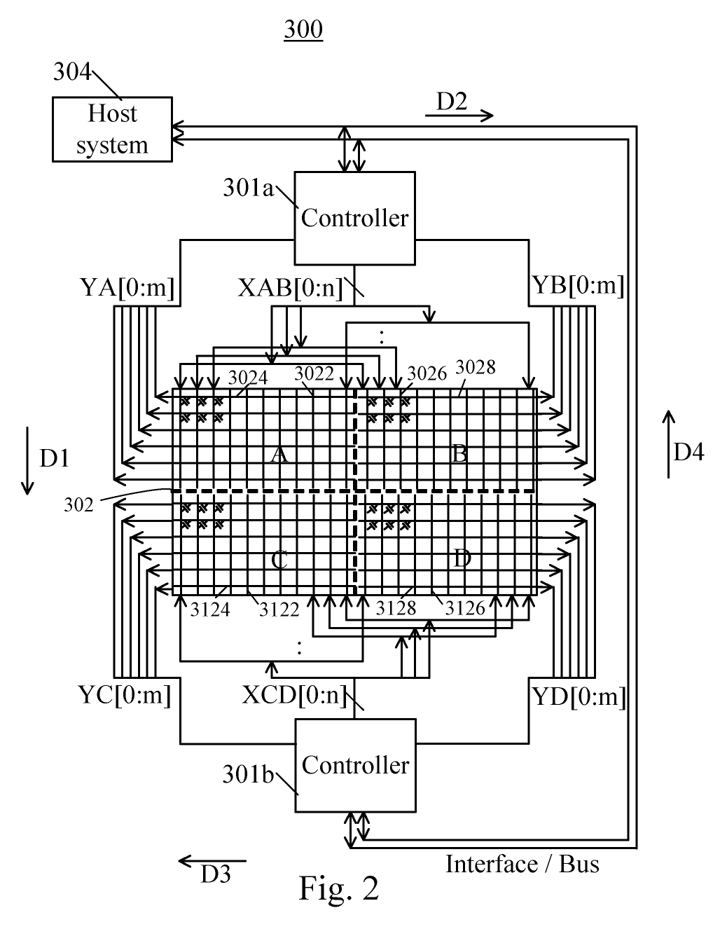

Please refer to FIG. 2, FIG. 2 illustrates a functional block diagram of a touch panel device 300 according to a first embodiment of the present invention. The touch panel device 300 comprises a control unit having two controllers 301a and 301b, a touch panel 302, and a host system 304. The host system 304 is used for controlling the operation of the touch panel device 100. The controller 101, implemented by a digital signal processor (DSP) or a software program code, is used for determining a touch position and magnitude of a force applied on the touch panel 102. The host system 304 is used for controlling the operation of the touch panel device 300. The controllers 301a and 301b, implemented by a digital signal processor (DSP) or a software program code, is used for determining a touch position and magnitude of a force applied on the touch panel 302.

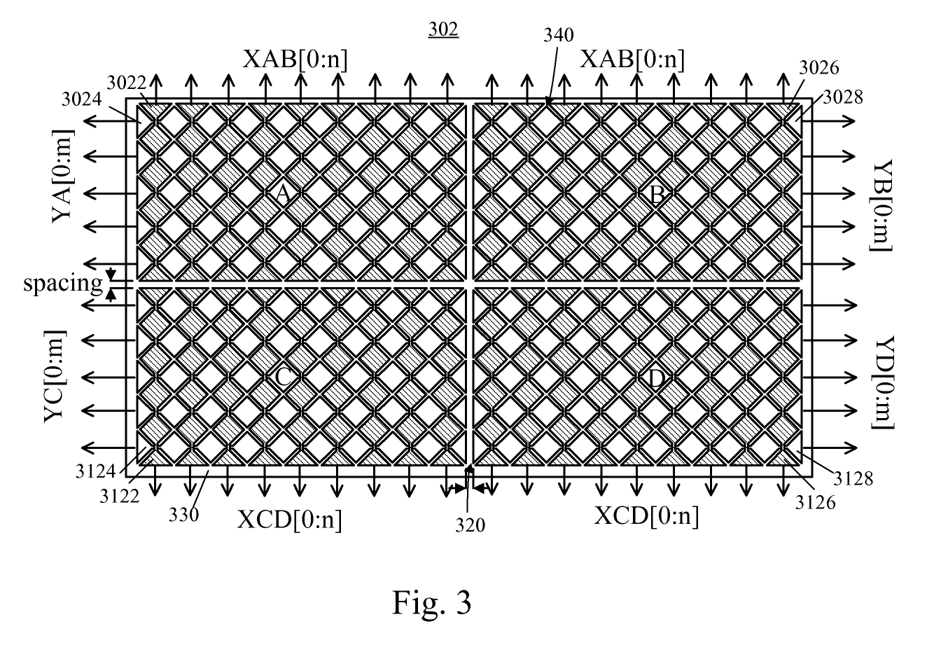

Please refer to FIG. 2 and FIG. 3. FIG. 3 shows a touch panel shown in FIG. 2. The touch panel 302 comprises a glass substrate 330 and an indium tin oxide (ITO) layer 340 thereon. The ITO layer 340 is divided into a first region A, a second region B, a third region C, and a fourth region D, each of which is apart from the others. Each of the first region A, the second region B, the third region C, and the fourth region D comprises two layers of electrical conductors or signal layers. The first region A comprises a plurality of first driving conductors 3022 extended along a first direction D1 (e.g. the columns of the touch panel 302), and a plurality of first sensing conductors 3024 extended along a second direction D2 (e.g. the rows of the touch panel 302) perpendicular to the first direction D1. The second region B comprises a plurality of second driving conductors 3026 extended along the first direction D1, and a plurality of second sensing conductors 3028 extended along the second direction D2. The third region C comprises a plurality of third driving conductors 3122 extended along the first direction D1 (e.g. the columns of the touch panel 302), and a plurality of third sensing conductors 3124 extended along the second direction D2 (e.g. the rows of the touch panel 302). The fourth region D comprises a plurality of fourth driving conductors 3126 extended along the first direction D1, and a plurality of fourth sensing conductors 3128 extended along the second direction D2. Preferably, a number of the first driving conductors 3022, a number of the second driving conductors 3026, a number of the third driving conductors 3122, and a number of the fourth driving conductors 3126 are identical, and a number of the first sensing conductors 3024, a number of the second sensing conductors 3028, a number of the third sensing conductors 3124, and a number of the fourth sensing conductors 3128 are identical. The intersections of the driving conductors 3022 and the sensing conductors 3024, or of the driving conductors 3026 and the sensing conductors 3028, or of the driving conductors 3122 and the sensing conductors 3124, or of the driving conductors 3126 and the sensing conductors 3128 are not physically and electrically contacted, forming the mutual capacitance sensing element of the touch panel 302. In addition, as shown in FIG. 3, each first driving conductor 3022 is not connected to one of the third driving conductor 3122. Each second driving conductor 3026 is not connected to one of the fourth driving conductor 3126. Each first sensing conductor 3024 is not connected to one of the second sensing conductor 3028. Each third sensing conductor 3124 is not connected to one of the fourth sensing conductor 3128. In other words, a cross-like gap 320 is located among the four regions A, B, C, and D.

A plurality of driving lines XAB[0:n] are electrically connected to the driving conductors 3022 and 3026, and a plurality of driving lines XCD[0:n] are electrically connected to the driving conductors 3122 and 3126. A plurality of first sensing lines YA [0:m] electrically connected to the first sensing conductors 3024, a plurality of second sensing lines YB [0:m] electrically connected to the second sensing conductors 3028, a plurality of third sensing lines YC [0:m] electrically connected to the third sensing conductors 3124, and a plurality of fourth sensing lines YD [0:m] electrically connected to the fourth sensing conductors 3128. The controller 301a outputs driving signals via the driving lines XAB[0:n] to the driving conductors 3022 and 3026, while the controller 301b outputs driving signals via the driving lines XCD[0:n] to the driving conductors 3122 and 3126. The controller 301a coupled to the sensing conductors 3024 and 3028 via the sensing lines YA [0:m] and YB [0:m] receives sensing signals, while the controller 301b coupled to sensing conductors 3124 and 3128 via the sensing lines YC [0:m] and YD[0:m] receives sensing signals.

The controller 301a outputs driving signals in an ordered sequence of the second direction D2 to drive the driving conductors 3022 and 3026, and receives sensing signals from the sensing conductors 3024 in an ordered sequence of a fourth direction D4 (or the first direction D1) and receives sensing signals from the sensing conductors 3028 in an ordered sequence of the first direction D1 (or the fourth direction D4). Meanwhile, the controller 301b outputs driving signals in an ordered sequence of the third direction D3 to drive the driving conductors 3122 and 3126, and receives sensing signals from the second sensing conductors 3124 in an ordered sequence of the fourth direction D4 (or the first direction D1), and receives sensing signals from the sensing conductors 3128 in an ordered sequence of the first direction D1 (or the fourth direction D4). When fingers, stylus pens, or other objects make one or more contacts of the touch panel 302, a certain point of the intersection of sensing conductors 3024, 3028, 3124, 3128 and the driving conductors 3022, 3026, 3122, 3126 is bound to induce a capacitance coupling phenomenon to cause the sensing signals generated by the sensing conductors 3024, 3028, 3124, 3128 to produce voltage variations. After each of the driving conductors 3022, 3026, 3122, 3126 is scanned one by one, an exact touch position can be obtained. The controllers 301a and 301b determine a touch position according to the voltage variations of the sensing signals.

Since the controllers 301a and 301b output driving signals via the driving lines XAB[0:n] and XCD [0:n] to the first driving conductors 3022 in the first region A, to the second driving conductors 3026 in the second region B, to the third driving conductors 3122 in the third region C, and to fourth driving conductors 3126 in the fourth region D simultaneously, the scan rate is increased. In addition, since each of the controllers 301a and 301b controls one half of the area of the touch panel 302, meaning that each of the controllers 301a and 301b is responsible for one half of the capacitance of the touch panel 302, the touch panel device 300 can be well controlled by the controller 301a and 301b without using a single controller with higher detecting sensibility and cost.

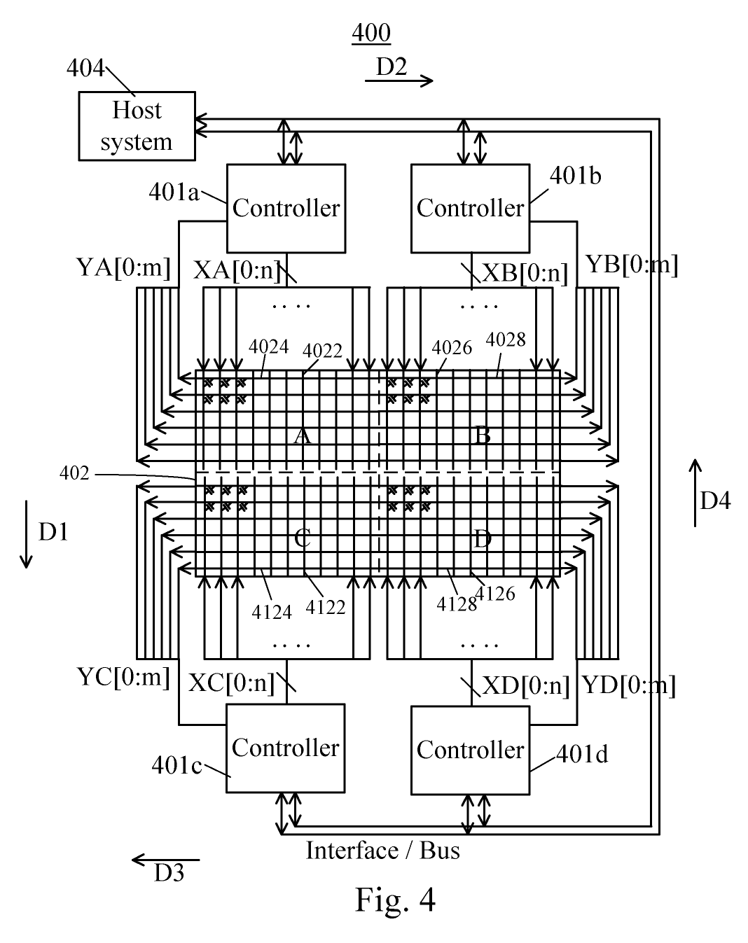

Please refer to FIG. 4, FIG. 4 illustrates a functional block diagram of a touch panel device 400 according to a second embodiment of the present invention. The touch panel device 400 comprises a control unit having four controllers 401a, 401b, 401c, and 401d, a touch panel 402, and a host system 404. The four controllers 401a, 401b, 401c, and 401d can be integrated into a single controller. The host system 404 is used for controlling the operation of the touch panel device 400. The controllers 401a, 401b, 401c, and 401d, implemented by a digital signal processor (DSP) or a software program code, are used for determining a touch position and magnitude of a force applied on the touch panel 402.

The touch panel 402 also comprises a glass substrate and an ITO layer thereon, as similar to the touch panel 302 shown in FIG. 3 and is omitted accordingly. The ITO layer of the touch panel 402 is divided into a first region A, a second region B, a third region C, and a fourth region D, each of which is apart from the others. Each of the first region A, the second region B, the third region C, and the fourth region D comprises two layers of electrical conductors. The first region A comprises a plurality of first driving conductors 4022 extended along a first direction D1 (e.g. the columns of the touch panel 402), and a plurality of first sensing conductors 4024 extended along a second direction D2 (e.g. the rows of the touch panel 402) perpendicular to the first direction D1. The second region B comprises a plurality of second driving conductors 4026 extended along the first direction D1, and a plurality of second sensing conductors 4028 extended along the second direction D2. The third region C comprises a plurality of third driving conductors 4122 extended along the first direction D1 (e.g. the columns of the touch panel 402), and a plurality of third sensing conductors 4124 extended along the second direction D2 (e.g. the rows of the touch panel 402). The fourth region D comprises a plurality of fourth driving conductors 4126 extended along the first direction D1, and a plurality of fourth sensing conductors 4128 extended along the second direction D2. Preferably, a number of the first driving conductors 4022, a number of the second driving conductors 4026, a number of the third driving conductors 4122, and a number of the fourth driving conductors 4126 are identical, and a number of the first sensing conductors 4024, a number of the second sensing conductors 4028, a number of the third sensing conductors 4124, and a number of the fourth sensing conductors 4128 are identical. The intersections of the driving conductors 4022 and the sensing conductors 4024, or of the driving conductors 4026 and the sensing conductors 4028, or of the driving conductors 4122 and the sensing conductors 4124, or of the driving conductors 4126 and the sensing conductors 4128 are not physically and electrically contacted, forming the mutual capacitance sensing element of the touch panel 402. In addition, each first driving conductor 4022 is not connected to one of the third driving conductor 4122. Each second driving conductor 4026 is not connected to one of the fourth driving conductor 4126. Each first sensing conductor 4024 is not connected to one of the second sensing conductor 4028. Each third sensing conductor 4124 is not connected to one of the fourth sensing conductor 4128.

A plurality of driving lines XA[0:n] are electrically connected to the driving conductors 4022, a plurality of driving lines XB[0:n] are electrically connected to the driving conductors 4026, a plurality of driving lines XC[0:n] are electrically connected to the driving conductors 4122, and a plurality of driving lines XD[0:n] are electrically connected to the driving conductors 4126. A plurality of first sensing lines YA [0:m] electrically connected to the first sensing conductors 4024, a plurality of second sensing lines YB [0:m] electrically connected to the second sensing conductors 4028, a plurality of third sensing lines YC [0:m] electrically connected to the third sensing conductors 4124, and a plurality of fourth sensing lines YD [0:m] electrically connected to the fourth sensing conductors 4128. In the meantime, the controller 401a outputs driving signals via the driving lines XA[0:n] to the driving conductors 4022; the controller 401b outputs driving signals via the driving lines XB[0:n] to the driving conductors 4026; the controller 401c outputs driving signals via the driving lines XC[0:n] to the driving conductors 4122; the controller 401d outputs driving signals via the driving lines XD[0:n] to the driving conductors 4126. The controller 401a coupled to the sensing conductors 4024 via the sensing lines YA [0:m] receives sensing signals. The controller 401b coupled to the sensing conductors 4028 via the sensing lines YB [0:m] receives sensing signals. The controller 401c coupled to sensing conductors 4124 via the sensing lines YC [0:m] receives sensing signals. The controller 401d coupled to sensing conductors 4128 via the sensing lines YD[0:m] receives sensing signals.

The controllers 401a and 401b synchronously output driving signals and output driving signals in an ordered sequence of the second direction D2 to drive the driving conductors 4022 and 4026. The controllers 401a receives sensing signals from the sensing conductors 4024 in an ordered sequence of a fourth direction D4 (or the first direction DD. The controllers 401b receives sensing signals from the sensing conductors 4028 in an ordered sequence of the first direction D1 (or the fourth direction D4). Meanwhile, the controller 401c and 401d synchronously output driving signals and output driving signals in an ordered sequence of the third direction D3 to drive the driving conductors 4122 and 4126. The controllers 401c receives sensing signals from the sensing conductors 4124 in an ordered sequence of a fourth direction D4 (or the first direction DD. The controllers 401d receives sensing signals from the sensing conductors 4128 in an ordered sequence of the first direction D1 (or the fourth direction D4).

When fingers, stylus pens, or other objects make one or more contacts of the touch panel 402, a certain point of the intersection of sensing conductors 4024, 4028, 4124, 4128 and the driving conductors 4022, 4026, 4122, 4126 is bound to induce a capacitance coupling phenomenon to cause the sensing signals generated by the sensing conductors 4024, 4028, 4124, 4128 to produce voltage variations. After each of the driving conductors 4022, 4026, 4122, 4126 is scanned one by one, an exact touch position can be obtained. The controllers 401a, 401b, 401c, and 401d determine a touch position according to the voltage variations of the sensing signals.

Since the controllers 401a, 401b, 401c, and 401d output driving signals via the driving lines XA[0:n], XB[0:n], XC[0:n] and XD[0:n] to the first driving conductors 4022 in the first region A, to the second driving conductors 4026 in the second region B, to the third driving conductors 4122 in the third region C, and to fourth driving conductors 4126 in the fourth region D simultaneously, the scan rate is increased. In addition, since each of the controllers 401a, 401b, 401c, and 401d controls one fourth of the area of the touch panel 402, meaning that each of the controllers 401a, 401b, 401c, and 401d is responsible for one fourth of the capacitance of the touch panel 402, the touch panel device 400 can be well controlled by the controller 401a, 401b, 401c, and 401d without using a single controller with higher detecting sensibility and cost.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A touch panel device comprising:
a touch panel comprising:
a first region comprising a plurality of first driving conductors extended along a first direction, and a plurality of first sensing conductors extended along a second direction perpendicular to the first direction;
a second region comprising a plurality of second driving conductors extended along the first direction, and a plurality of second sensing conductors extended along the second direction;
a third region comprising a plurality of third driving conductors extended along the first direction, and a plurality of third sensing conductors extended along the second direction;
a fourth region comprising a plurality of fourth driving conductors extended along the first direction, and a plurality of fourth sensing conductors extended along the second direction;
a first controller electrically connected to the first driving conductors, the second driving conductors, the first sensing conductors, and the second sensing conductors, for outputting the plurality of driving signals to drive the plurality of first driving conductors and the plurality of second driving conductors, for receiving the plurality of sensing signals from the plurality of first sensing conductors, and for receiving the plurality of sensing signals from the plurality of second sensing conductors; and
a second controller electrically connected to the third driving conductors, the fourth driving conductors, the third sensing conductors, and the fourth sensing conductors, for outputting the plurality of driving signals to drive the plurality of third driving conductors and the plurality of fourth driving conductors, for receiving the plurality of sensing signals from the plurality of third sensing conductors, and for receiving the plurality of sensing signals from the plurality of fourth sensing conductors,
wherein each first driving conductor is not connected to one of the third driving conductor, each second driving conductor is not connected to one of the fourth driving conductor, each first sensing conductor is not connected to one of the second sensing conductor, and each third sensing conductor is not connected to one of the fourth sensing conductor.

2. The touch panel device as claimed in claim 1 wherein a number of the first driving conductors, a number of the second driving conductors, a number of the third driving conductors, and a number of the fourth driving conductors are identical, and a number of the first sensing conductors, a number of the second sensing conductors, a number of the third sensing conductors, and a number of the fourth sensing conductors are identical.

3. The touch panel device as claimed in claim 1 wherein a cross-like gap is located among the first, second, third and fourth regions.

4. A touch panel device comprising:
a touch panel comprising:
a first region comprising a plurality of first driving conductors extended along a first direction, and a plurality of first sensing conductors extended along a second direction perpendicular to the first direction;
a second region comprising a plurality of second driving conductors extended along the first direction, and a plurality of second sensing conductors extended along the second direction;
a third region comprising a plurality of third driving conductors extended along the first direction, and a plurality of third sensing conductors extended along the second direction;
a fourth region comprising a plurality of fourth driving conductors extended along the first direction, and a plurality of fourth sensing conductors extended along the second direction;
a first controller electrically connected to the first driving conductors and the first sensing conductors, for outputting the plurality of driving signals to drive the plurality of first driving conductors, and for receiving the plurality of sensing signals from the plurality of first sensing conductors;
a second controller electrically connected to the second driving conductors and the second sensing conductors, for outputting the plurality of driving signals to drive the plurality of second driving conductors, and for receiving the plurality of sensing signals from the plurality of second sensing conductors;
a third controller electrically connected to the third driving conductors and the third sensing conductors, for outputting the plurality of driving signals to drive the plurality of third driving conductors, and for receiving the plurality of sensing signals from the plurality of third sensing conductors; and
a fourth controller electrically connected to the fourth driving conductors and the fourth sensing conductors, for outputting the plurality of driving signals to drive the plurality of fourth driving conductors, and for receiving the plurality of sensing signals from the plurality of fourth sensing conductors,
wherein each first driving conductor is not connected to one of the third driving conductor, each second driving conductor is not connected to one of the fourth driving conductor, each first sensing conductor is not connected to one of the second sensing conductor, and each third sensing conductor is not connected to one of the fourth sensing conductor.

5. The touch panel device as claimed in claim 4 wherein a number of the first driving conductors, a number of the second driving conductors, a number of the third driving conductors, and a number of the fourth driving conductors are identical, and a number of the first sensing conductors, a number of the second sensing conductors, a number of the third sensing conductors, and a number of the fourth sensing conductors are identical.

6. The touch panel device as claimed in claim 4 wherein a cross-like gap is located among the first, second, third and fourth regions.
